(19) United States
(12) Patent Application Publication
(10) Pub. No.: US 2008/0097721 A1
(43) Pub. Date: Apr. 24, 2008

(54) MEASURE MODULE

(75) Inventor: HSIN-CHIH TUNG, TAO-YUAN HSIEN (TW)

Correspondence Address: ROSENBERG, KLEIN & LEE, 3458 ELLICOTT CENTER DRIVE-SUITE 101, ELLICOTT CITY, MD, 21043, US

(73) Assignee: LECC TECHNOLOGY CO., LTD., TAO YUAN HSIEN (TW)

(21) Appl. No.: 11/877,131

(22) Filed: Oct. 23, 2007

(30) Foreign Application Priority Data
Oct. 24, 2006 (TW) 95218770

(51) Int. Cl. G01B 21/22

(52) U.S. Cl. 702/151; 33/1 PT

(57) ABSTRACT

The present invention relates to a measure module. The measure module is installed on an inclinable machine tool. The machine tool has an inclinable member. The measure module includes a monitor and a sensor. The sensor is electrically connected with the monitor. The sensor is installed on the inclinable member. As a result, when the machine tool is adjusted to an angle, the measure module can display the angle via the monitor. It can achieve the adjustment of the angle quickly and accurately.

### BACKGROUND OF THE INVENTION

1. Field of the Invention

The present invention relates to a measure module installed on a machine tool, and in particular to a measure module that can measure and display an angle of the machine tool quickly.

2. Description of the Prior Art

A conventional machine tool like a bandsaw or a drilling machine can be used at an angle. The machine tool has a member which a knife or a drill is installed thereon. The member is designed inclinable for the knife or the drill to cut or drill a workpiece inclinedly.

When the above machine tool is adjusted at an angle, the angle relies on a scale thereon to display. The way to display an angle by the scale is inexactitude and unconvenient to operate for users. It also costs a lot of time to adjust at the angle.

Therefore, in view of this, the inventor proposes the present invention to overcome the above problems based on his expert experience and deliberate research.

### SUMMARY OF THE INVENTION

An object of the present invention is to provide a measure module for a machine tool to adjust an angle quickly and accurately.

In order to achieve the above object, the present invention provides a measure module for a machine tool. The machine tool has an inclinable member. The measure module comprises a monitor and a sensor. The sensor is electrically connected with the monitor. The measure module is installed on the inclinable member of the machine tool.

The advantages of the present invention lie in that the measure module is installed on the inclinable member of the machine tool. When the machine tool is at an angle, the monitor can be used to display the angle. The way to show the angle is accurate. The measure module is convenient to operate for users and can achieve the angle of adjustment quickly.

In order to better understand the characteristics and technical contents of the present invention, a detailed description thereof will be made with reference to the accompanying drawings. However, it should be understood that the drawings and the description are illustrative and should not be used to limit the scope of the present invention.

### BRIEF DESCRIPTION OF THE DRAWINGS

FIG. 1 is a perspective view showing a measure module;

FIG. 2 is a perspective view showing a measure module installed on a bandsaw;

FIG. 3 is a perspective view showing a measure module installed on a drilling machine;

FIG. 4 is a perspective view showing a measure module installed on another bandsaw.

### DETAILED DESCRIPTION OF THE INVENTION

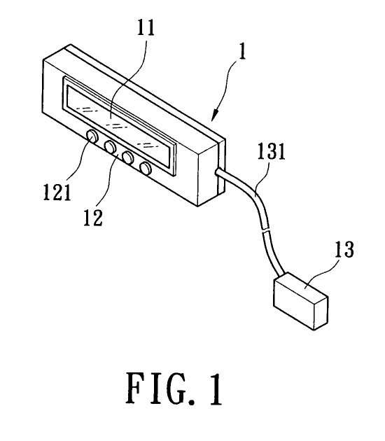

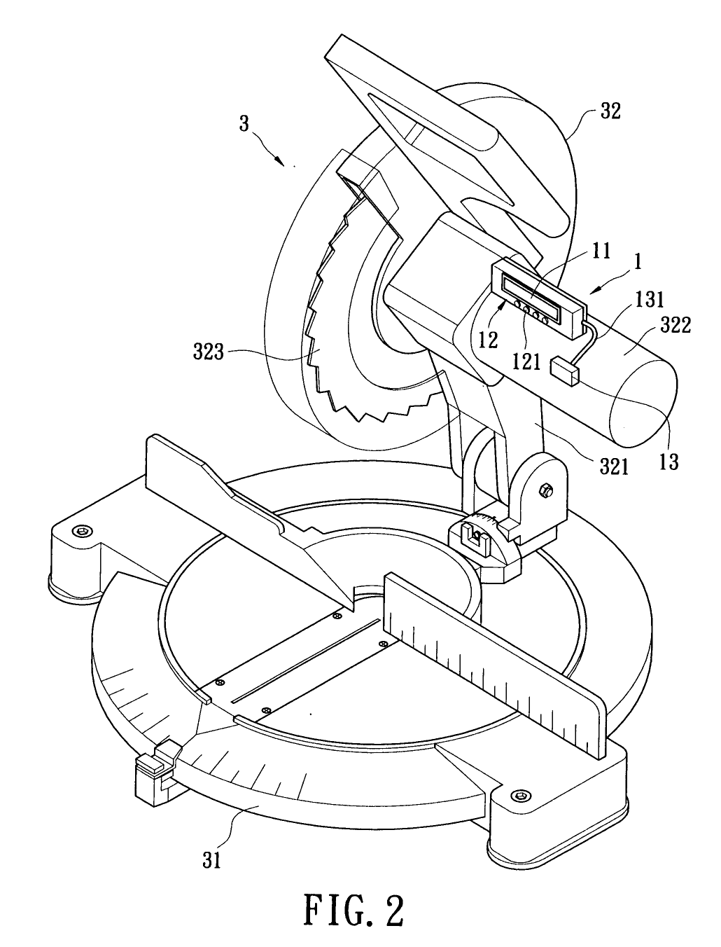

Please refer to FIG. 1 and FIG. 2, in which the present invention of a measure module is shown. The measure module can be installed on a machine tool. In the embodiment of the present invention the measure module 1 is installed on a bandsaw 3. The bandsaw 3 includes a foundation 31 and an inclinable member 32. The inclinable member 32 comprises an adjustment part 321, a motor 322, and a knife 323. The adjustment part 321 pivoted on the foundation 31 can be adjusted at a different angle corresponding to the foundation 31. The motor 322 is fixed on the adjustment part 321. The knife 323 connected to the shaft of the motor 322 can be driven by the motor 322 to rotate to cut a workpiece like wood. The workpiece can be cut to form a bevel which we need via the adjustment part 321.

The measure module 1 includes a monitor 11, a control unit 12, and a sensor 13. The monitor 11 is like a LCD (liquid crystal display) or a LED (Light Emitting Diode) monitor.

The control unit 12 is electrically connected with the monitor 11. The control unit 12 can be designed to separated from the monitor 11 or combined with the monitor 11. In the embodiment the control unit 12 is combined with the monitor 11. The control unit 12 comprises a circuit board, several batteries for supplying power (not shown in the Figs.) and a plurality of keys 121. The keys 121 are electrically connected with the circuit board. The control unit 12 has the functions of on/off, setting and adjusting.

The sensor 13 is electrically connected with the control unit 12 and the monitor 11. The sensor 13 can be designed to separate from the control unit 12 and the monitor 11 or combine with the control unit 12 and the monitor 11. In the embodiment, the sensor 13 is separated from the control unit 12 and the monitor 11. The sensor 13 is electrically connected with the control unit 12 via a signal line 131. The sensor 13 is used for detecting a bevel corresponding to level and transmitting signals to the control unit 12 and the monitor 11. It shows the angle by the monitor 11.

Please refer to FIG. 2, in which the present invention of a measure module 1 installed on a bandsaw 3 is shown. The bandsaw 3 has an inclinable member 32. The measure module 1 is installed on the inclinable member 32 of the bandsaw 3. In the embodiment, the monitor 11 and the sensor 13 are installed on the front side of the motor 322. When the inclinable member 32 of the bandsaw 3 is used to adjust an angle, the sensor 13 can detect the angle and transmit it to the control unit 12 and the monitor 11. The angle is shown via the monitor 11.

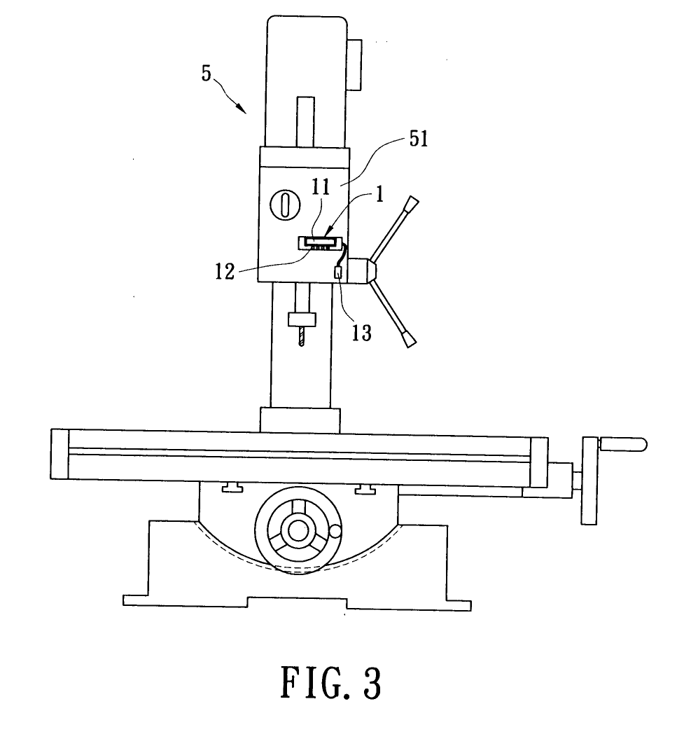

Please refer to FIG. 3 showing the measure module 1 installed on a drilling machine 5. The drilling machine has an inclinable member 51. The sensor 13 is installed on the inclinable member 51 of the drilling machine 5. When the inclinable member 51 of the drilling machine 5 is used to adjust an angle, the sensor 13 can detect the angle and transmit it to the control unit 12 and the monitor 11. The angle is shown via the monitor 11. Furthermore, the present invention of the measure module 1 also can be installed on a milling machine or other machine tools which have an inclinable member.

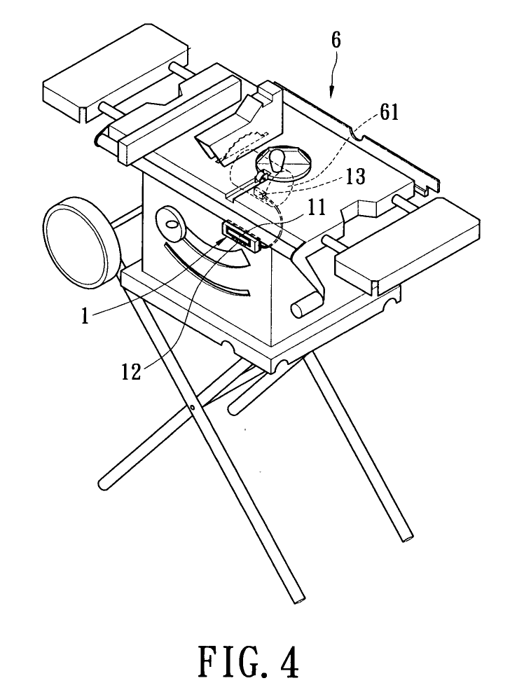

Please refer to FIG. 4 showing the measure module 1 installed on another type of bandsaw 6. The sensor 13 is installed on an inclinable member 61 of the bandsaw 6.

In the above embodiments, the measure module 1 is installed on the machine tool via external connection. The measure module 1 also can be installed on the machine tool via internal connection.

When the machine tool is adjusted to an angle, the measure module 1 can display the angle via the monitor 11. The way of the display is accurate and convenient to operate for users. It can achieve the adjustment of the angle quickly and increase the convenience to the machine tool.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An measure module installed on a machine tool for measuring an angle of the machine tool with an inclinable member, comprising:
a monitor; and
a sensor electrically connected with the monitor, the sensor installed on the inclinable member of the machine tool.

2. The measure module as claimed in claim 1, wherein the monitor and the sensor are electrically connected with a control unit.

3. The measure module as claimed in claim 2, wherein the control unit comprises a circuit board, several batteries, and a plurality of keys, and the keys are electrically connected with the circuit board.

4. The measure module as claimed in claim 2, wherein the sensor is electrically connected with the control unit via a signal line.

5. The measure module as claimed in claim 1, wherein the monitor is LCD (liquid crystal display) or LED (Light Emitting Diode).

6. The measure module as claimed in claim 1, wherein the measure module is installed on the machine tool via external connection.

7. The measure module as claimed in claim 1, wherein the measure module is installed on the machine tool via built-in manner.

8. The measure module as claimed in claim 1, wherein the machine is a bandsaw, a drilling machine, or a milling machine.
